(19) United States
(12) Patent Application Publication
(10) Pub. No.: US 2018/0151266 A1
(43) Pub. Date: May 31, 2018

(54) NEW GENERATION CONDUCTIVE POLYMERS, MANUFACTURING METHOD THEREOF, AND THEIR APPLICATIONS INCLUDING ELECTRIC WIRES, TAPES, AND CABLES, HOT SURFACE IGNITERS, ELECTRONICS DEVICES, 3D PRINTING FILAMENTS, AND LIGHTWEIGHT MATERIALS FOR AUTOMOBILE AND AEROSPACE SHIP

(71) Applicant: Yong-Jihn KIM, Mayaguez, PR (US)

(72) Inventor: Yong-Jihn KIM, Mayaguez, PR (US)

(21) Appl. No.: 15/570,553

(22) PCT Filed: Apr. 29, 2016
(86) PCT No.: PCT/US2016/029942

§ 371 Date: Oct. 30, 2017

Related U.S. Application Data
(60) Provisional application No. 62/155,479, filed on May 1, 2015.

(51) Int. Cl. H01B 1/02; H01F 1/03; H01B 1/04

(52) U.S. Cl. CPC H01B 1/02; H01B 1/04; H01F 1/0306

(57) ABSTRACT

The invention relates to inorganic conductive polymer with a melting point over 1,000° C., based on C, Mg, and B, comprising both magnetic and nonmagnetic ions. They form amorphous polymer phase and the electrical resistivity can be varied from 10⁻⁶ Ωcm to 10¹⁸ Ωcm. They are very hard, durable, and very light. The conductive polymers can be used for electric wires, tapes, and cables, hot surface igniters, electronic devices, such as LED, solar cell, mobile screen, laptop screen, battery, and supercapacitor, and structural materials for automobile and aerospace ship. It can be also used for radiation-resistant material.

### CROSS-REFERENCE TO RELATED APPLICATIONS

This application is the entry into national phase of International Application No. PCT/US16/29942, filed on Apr. 29, 2016, the content of which is hereby incorporated by reference in its entirety, which claims the benefit of U.S. Provisional Patent Application Ser. No. 62/155,479 entitled “New Generation Conducting Plastics, Manufacturing Method Thereof, and their Applications including hot surface igniters, electronics devices, 3d printing, and lightweight materials for automobile and aerospace”, filed on May 1, 2015, the entire disclosures of which are incorporated herein by reference.

### FEDERALLY SPONSORED RESEARCH

“This invention was made with Government support under NSF SBIR, 1315159, awarded by the National Science Foundation. The Government has certain rights in this invention.”

### TECHNICAL FIELD

This invention relates to new type of conductive polymers or plastics with a high melting point over 1,000° C., their synthesis, and their use in electrical wires, tapes, and cables, electronic devices, hot surface igniters, 3d printing, radiation-shielding materials for space research, and light-weight structural materials for automobile and aerospace industry.

### BACKGROUND ART

Polyacetylene was found to be highly conducting like metals due to p-doping [A. J. Heeger et. Al., U.S. Pat. No. 4,222,903], and this discovery opened up a new frontier of conductive polymers. However, its physical and mechanical properties turned out to be not good enough for practical applications. Subsequently, other conductive polymers were found, such as polyanilines, polypyrrole, poly (p-phenylene vinylene) (PPV), and Poly (3,4-ethylenedioxythiophene) (PEDOT).

These conductive polymers are basically conjugated polymers which can be electrically conducting due to doping.

Currently conductive polymers are used for electronic devices, such as Light Emitting Diodes (LEDs), Solar cells, mobile displays, laptop displays, field effect transistors, biosensors, and supercapacitors [M. Ates, T. Karazehir, and A. S. Sarac, Conducting Polymers and Their Applications, Current Physical Chemistry, 2, 224 (2012)]. In particular, PEDOT is used in a wide range of applications, such as antistatic coatings, transparent and flexible electrode, low ESR (Equivalent Series Resistance) electrolytic capacitors, organic LEDs for displays and lighting applications, and organic solar cells. But these polymers require expensive processes and they are vulnerable to heat, whereas this new generation inorganic conductive polymers are cost-effectively manufactured and have a high melting point over 1,200° C.

Note that PEDOT can have conductivity 1,000 S/cm, i.e., resistivity 10^{˜3} Qcm, which is not good enough for electric power transmission and distribution. The new generation conductive polymer can have resistivity about 1.5×10^{″6} Qcm, opening up an opportunity in electric wires and cables for electric power industry. Polyacetylene can be synthesized in a highly crystalline form (90% crystallinity and 10% amorphous phase) with a conductivity of an order of 105 S/cm [M. Angelopoulos et al., U.S. Pat. No. 6,616,863], although its application is not feasible due to non-soluble, non-processable, and environmentally unstable nature of the polymer.

The Boron based polymers, such as Boron Nitride polymers [M. Cote, P. D. Haynes, and C. Molteni, Phys. Rev. B 63, 125207 (2001)] don't have good electrical properties. On the other hand, the conductive hybrid plastics by Electriplast Corp, are available, which require expensive nanotechnology based manufacturing, though.

Copper is dominating in electrical industry over hundred years with well-established wire manufacturing technology. The most common conductor for high voltage 13,200V power transmission is aluminum conductor steel reinforced (ACSR), whereas Copper is used for lower voltage 4,160V power distribution. The patent on the copper clad aluminum wire (CCAW) is rather old and has been expired [Kudo et al., U.S. Pat. No. 5,223,349]. We expect these conductive polymers will lead to excellent quality Cu sheathed wires, superior than Cu-cladded Aluminum wires (CCAW) and aluminum conductor steel reinforced (ACSR) and even comparable to pure copper wires, with much reduced prices, much lighter weight, and much better heat tolerance. Magnesium and magnesium alloys are used for automobile wheels and other automobile parts due to low density and high strength-to-weight ratio [Z. Yang et al., Acta. Metall Sin. 21, 313 (2008)]. Magnesium has density 1.74 g/cm³, whereas Mg—Li alloy has density 1.4 g/cm³, respectively.

Light weight of this conductive polymer with the density about 1 g/cm³, is an advantage over metals for applications, such as electric wiring and structure material for automobile and aircraft. This new generation conductive polymer is durable, very light, and very strong, which is a viable option for light-weight structure material for automobile and aircraft. Currently SiC and SiN are used for hot surface igniters. SiC is fragile and SiN is more expensive. This New Generation conducting polymers can be used for hot surface igniters. Compared to the current SiC and SiN surface igniters, this conductive polymers will be much cheaper and more durable.

### SUMMARY

One embodiment exemplarily described herein can be generally characterized as an inorganic conductive polymer with a high melting pint over 1,000° C. The new conductive polymer may comprise Carbon, Mg, and Boron, with nonmagnetic elements, such as Sc, Ti, Ca, and O, and magnetic elements, such as Fe, Co, Ni, and n. Its electrical resistivity can be varied from 10˜6 Qcm to 1018 □cm, by changing the concentration of ingredients.

Another embodiment exemplarily described herein can be generally characterized as a method for manufacturing a conductive polymer. The method may include preparing a conductive polymer with a melting point over 1,000° C., comprising:
preparing a material, comprising C, Mg and B;
forming magnetic ions in the material; and forming non-magnetic ions in the material,
wherein the electrical resistivity is varied from 10^{˜6} ohmcm to 10¹⁸ ohmcm. Yet another embodiment exemplarily described herein can be generally characterized as electric wires, tapes, and cables, hot surface igniters, electronic devices, such as battery, solar cell, LED, supercapacitor, and electrolyte, and light-weight structural materials for automobile and aerospace industry, comprising the polymer described herein.

These and other aspects of the invention will become evident by reference to the following description of the invention, often referring to the accompanying drawings.

### BRIEF DESCRIPTION OF THE DRAWINGS

FIG. 1 shows the manufacturing process of prototype conductive polymer samples.

FIG. 2 shows the typical new generation conductive polymer, fabricated by the pressed pellet technique.

FIG. 3 shows the SEM image of the conductive polymer.

FIG. 4 shows XRD of the conductive polymer.

FIG. 5 shows XRD of the usual polymer, Poly (Lactic Acid).

FIG. 6 shows the piece of a conductive polymer mounted on the sample holder (a) of PPMS (Physical Property Measurement System), (b), with the resistance of 25Ω.

FIG. 7 shows the resistance, 3.3 mQ, of a conductive polymer.

FIG. 8 shows the floating conductive polymer powders.

FIG. 9 shows melting point test result using the 1,150° C. muffle furnace.

FIG. 10 shows schematic picture of positioning of the New Generation Conductive Polymers among materials.

FIG. 11 shows the comparison of conductivities of current conductive polymers and this new generation conductive polymers.

FIG. 12 shows the schematic phase diagram of the new generation conductive polymers. MC and NMC mean Magnetic component and Nonmagnetic component, respectively.

### DETAILED DESCRIPTION

Embodiments of the present invention can be generally characterized as an inorganic conductive polymer with a high melting point over 1,000° C., comprising Carbon, Mg, and Boron, with nonmagnetic elements, such as Sc, Ti, Ca, and O, and magnetic elements, such as Fe, Co, Ni, and Mn. They are extremely durable, hard, and very light, with the density around 1 g/cm³. Their electrical and mechanical properties can be easily manipulated by changing the concentrations of ingredients. For instance, we expect that the resistivity can be varied from 10^{˜6} Qcm to 10¹⁸ Qcm, by changing the concentration of ingredients.

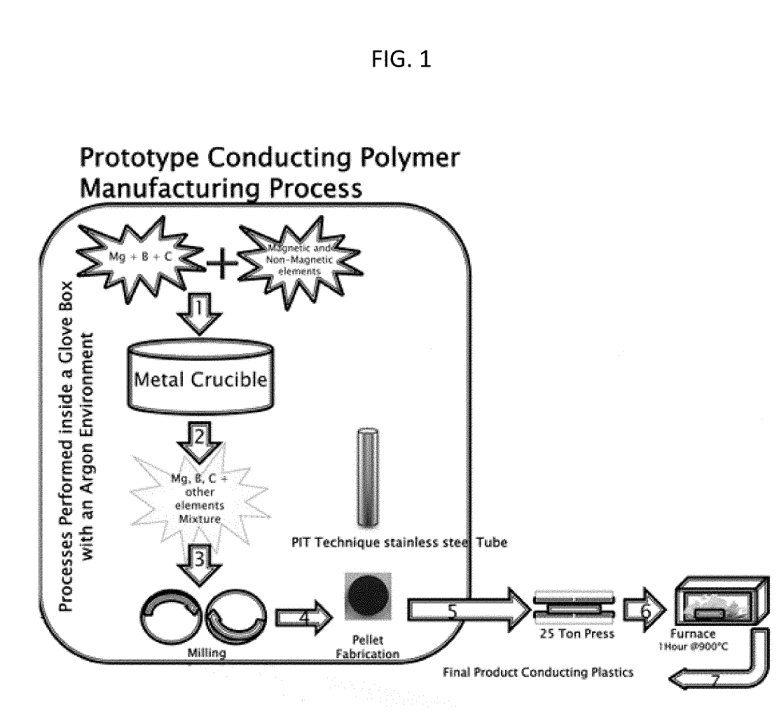

Embodiments of the present invention are achieved by the discovery of new generation conductive polymer with a melting point over 1,000° C. during high temperature and high pressure sintering of gB2, by adding magnetic and nonmagnetic impurities, according to the U.S. Pat. No. 7,791,343 by Y.-J. Kim, and supported by NSF SBIR Phase I award, 1315159. The high temperature over 900° C. and high-pressure sintering unveiled the exotic chemical reaction to produce the new generation conductive polymers with a melting point over 1,000° C. It seems to be the tip of iceberg for high temperature phase inorganic conductive polymers. FIG. 1 illustrates the manufacturing process of conductive polymer samples, in accordance with an embodiment of the present invention. Both powder-in-tube (PIT) technique [N. Varghese, K. Vinod, A. Rao, Y. K. Kuo, and U. Syamaprasad, J. Alloys compd, 470, 63 (2009)] and pellet fabrication process can be used for manufacturing conductive polymers. Powders of C, Mg, B, and magnetic and nonmagnetic elements are mixed stoichiometrically, and pressed in the stainless-steel tube or in the pellet die. For sintering, heat is applied at over 900° C. at least one hour. Basically, solid state reaction is used to make bulk conductive polymers, which is easily scalable for large scale manufacturing and good quality control. In addition, this process is cheaper than the usual manufacturing process of conductive polymers.

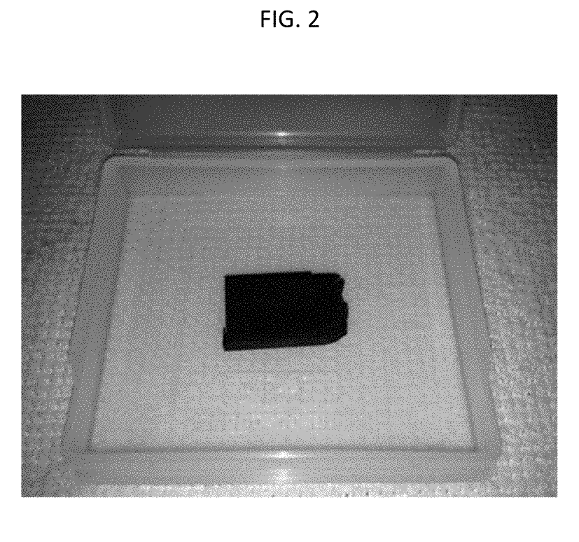

FIG. 2 illustrates a typical conductive polymer fabricated by pellet technique in accordance with an embodiment of the present invention.

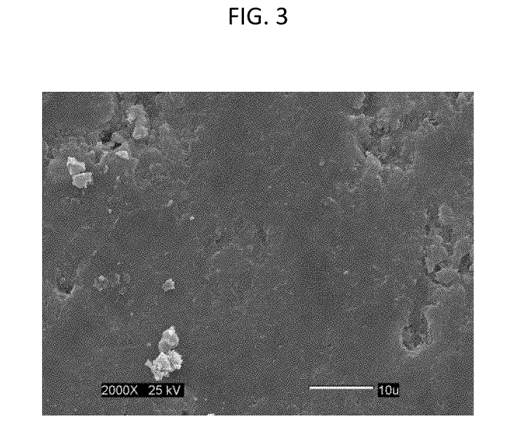

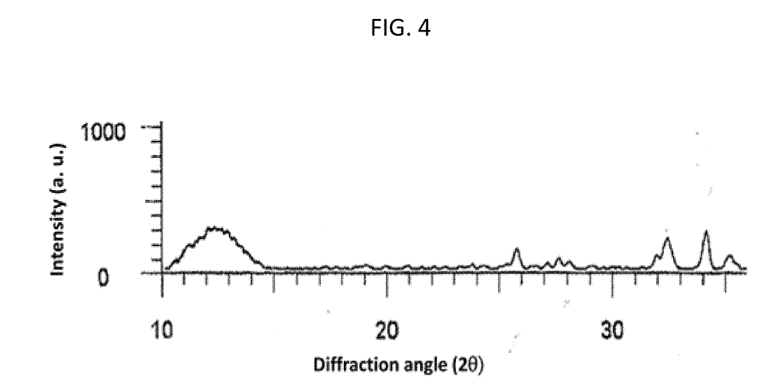

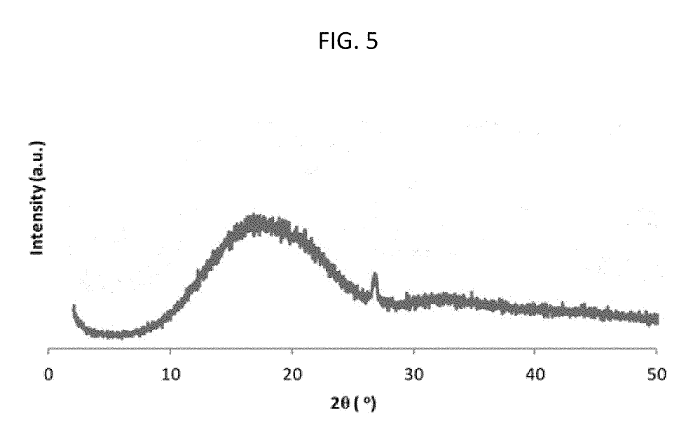

FIG. 3 illustrates SEM image of the conductive polymer Amorphous phase is clearly seen. It is stressed that it is not porous. The XRD pattern in FIG. 4 confirms the amorphous phase of the conductive polymer. FIG. 5 illustrates XRD pattern of the typical polymer, Poly (lactic acid) for comparison [B. W. Chieng, N. A. Ibrahim, W. M. Z. Yunus, M. Z. Hussein, Y. Y. Then, and Y. Y. Loo, Polymers, 6, 2232 (2014)]. Note the broad XRD peaks in both cases.

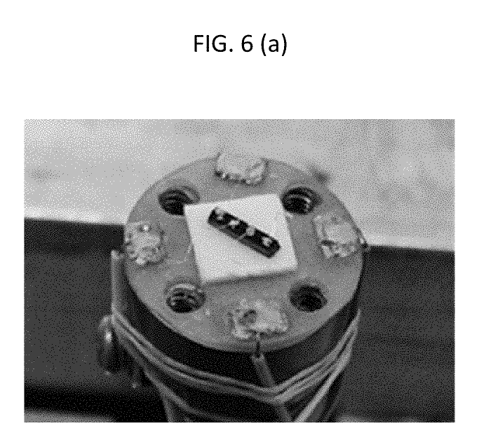

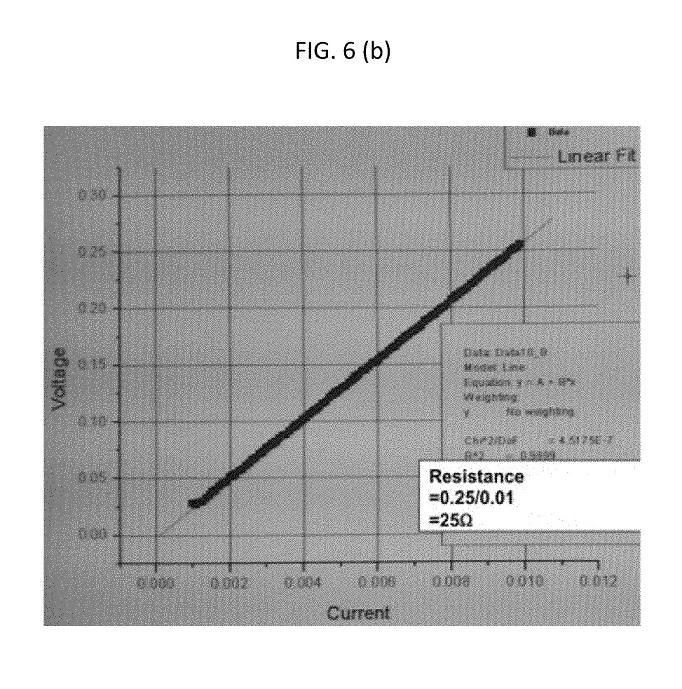

A small piece was cut from the conductive polymer in FIG. 2 for electrical resistance measurement by PPMS (Physical Property Measurement), as shown in FIG. 6. The resistance was about 25Ω at room temperature.

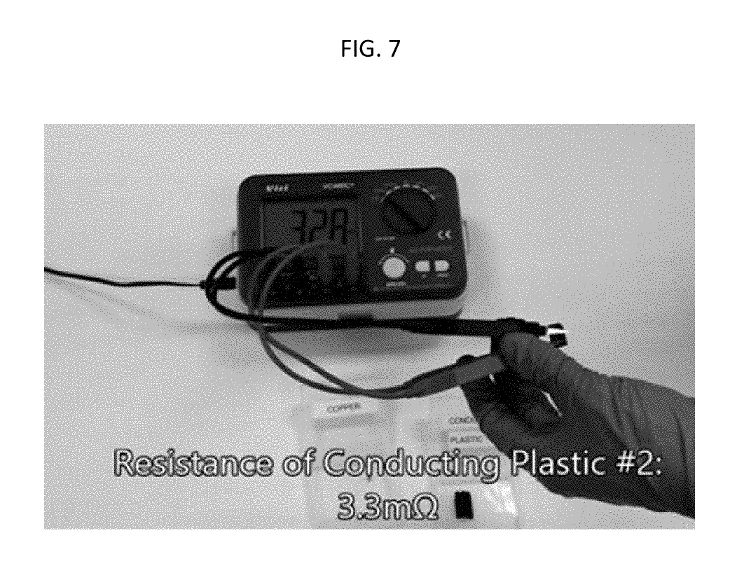

The resistance of conducting polymers can be easily tuned by changing the concentrations of ingredients, as shown in FIG. 7. The resistance is about 3.3 milliQ. It turns out that Boron was not crucial for increasing conductivity of the sample, although Boron can be used to make samples to have desirable properties, such as more durable, sturdy, and more stable.

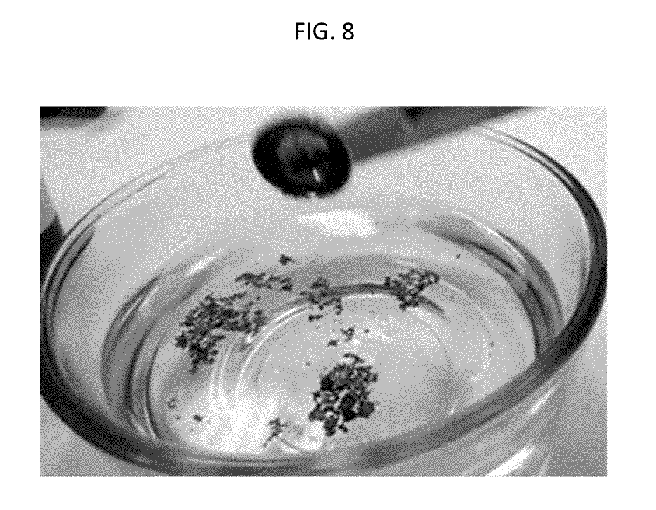

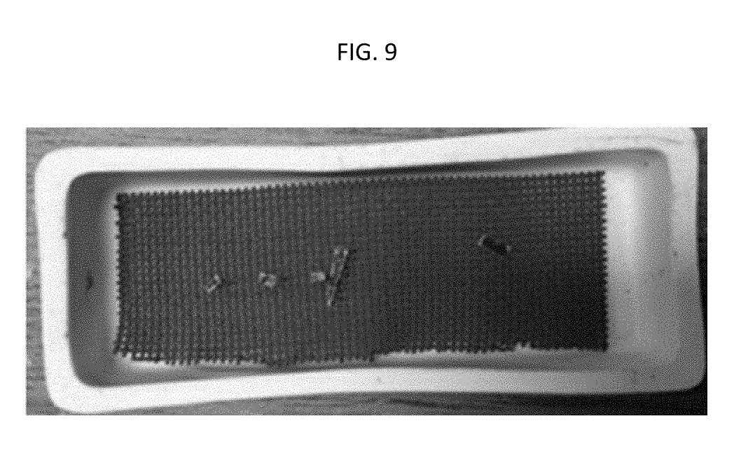

It is fascinating to see that this inorganic conductive polymer powders are floating on the water, as shown in FIG. 8. It is clear that the pure conductive polymer has mass density around 1.0 g/cm³. In fact, the density of the sample is about 1.15 g/cm³, due to some oxidation. As we reduce the oxygen contamination, the resistivity reached 2.88×10^{˜6} Qcm, compared to 1.67×10^{″6} Qcm of Copper. The melting point seems to be over 1,200° C., although it was tested only up to 1,150° C. by a muffle furnace, due to the lack of the necessary furnace, as shown in FIG. 9. Nevertheless, the conductive polymers on the 316 stainless steel meash show structural integrity up to that temperature without any sign of damage. The white spots are due to the oxidation during the heat treatment in the muffle furnace. In addition, the 3,000° C. Benzomatic torch was used to melt those polymers without success, confirming the very high melting point.

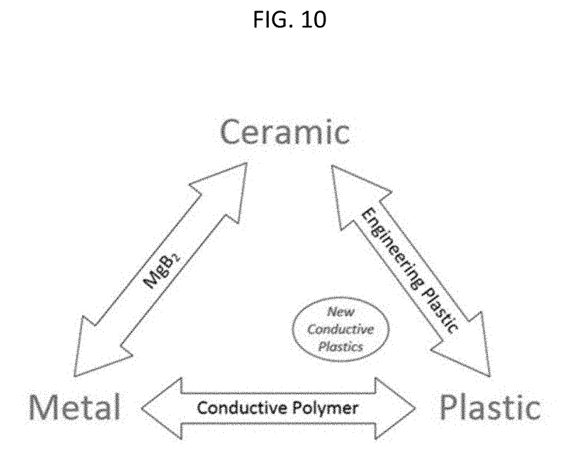

Although the molecular structure of the new generation conductive polymer has not been identified yet, it has unique excellent properties, because it shares some useful properties of metals, ceramics and plastics, as shown in FIG. 10, which illustrates the schematic picture of positioning of the New Generation Conducting Polymers among materials. Note that gB2 is a ceramic metal, with both covalent bond and metallic bond, whereas conductive polymers are conjugated polymers with a Carbon backbone chain of alternating double- and single-bonds. Their overlapping p-orbitals leads to metallic behavior. The engineering plastics also have unique combination of properties, such as resistance to heat, abrasion, impact, and fire.

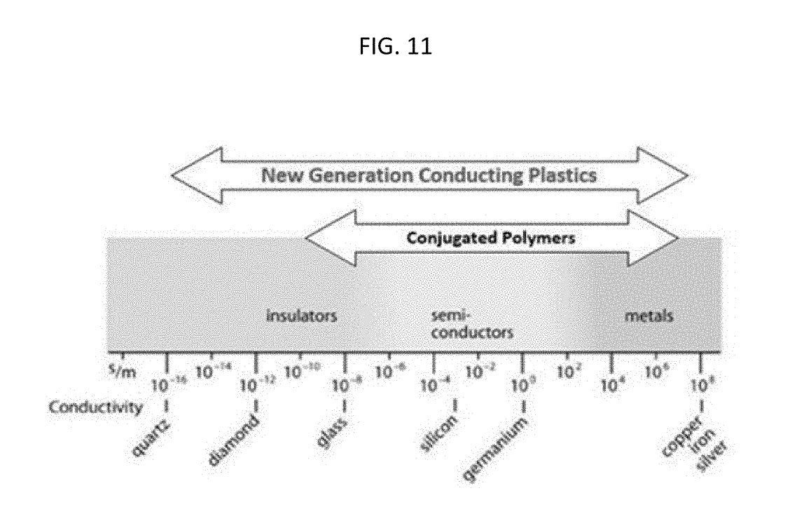

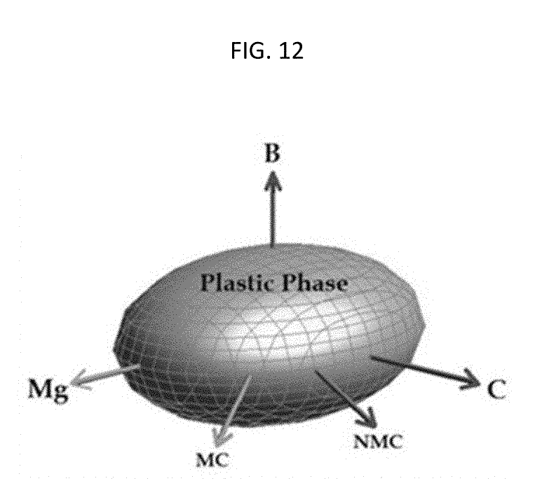

FIG. 11 illustrates the schematic picture of the comparison of conductivities of current conductive polymer and this new generation conductive polymers. FIG. 12 illustrates schematic phase diagram for new generation conductive polymer (plastic). MC and NMC mean Magnetic component and Nonmagnetic component, respectively. Carbon seems to form the main backbone of (conjugated) polymer, whereas Boron can substitute portion of C. Therefore, Boron is not that essential, although Boron may make samples to have some desirable properties. The magnetic and nonmagnetic ions make the polymer more conducting.

According to some embodiments of the present invention, magnetic impurities can, for example, include at least one selected from the group consisting of an ion with partially-filled d-electrons (i.e., a transition metal) such as Mn, Fe, Ni, Cr, Co, Ru, Rh and the like; an ion with partially-filled f-electrons (i.e., a rare earth element) such as Ce, Pr, Nd, Pm, Sm, Eu, Gd, Tb, Dy, Ho, Er, Tm, U and the like; and a magnetic nanoparticle (e.g., a magnetic precipitate).

According to some embodiments of the present invention, non-magnetic ions can, for example, include at least one selected from the group consisting of a non-magnetic ion with an s-electron and/or a p-electron such as Zn, Al, Ca, Sc, Ti, V, O, S, Li, and the like.

The optimum amount of magnetic ions and non-magnetic ions can be determined from the optimum electrical and mechanical properties. In one embodiment, the concentration of magnetic ions may range from 0.1 at. % to 20 at. % of the polymer material.

In one embodiment, the concentration of non-magnetic ions may range from 1 at. % to 40 at. % of the polymer material.

Another embodiment exemplarily described herein can be generally characterized as a method for manufacturing an inorganic conductive polymer with a melting point over 1,000° C. The method for manufacturing a conductive polymer with a melting point over 1,000° C., may include preparing a material, comprising C, Mg and B, forming magnetic ions in the material, and forming non-magnetic ions in the material, wherein the electrical resistivity is varied from 10^{˜6} Qcm to 10¹⁸ Qcm.

According to embodiments of the present invention, any available technique can be used to manufacture the conductive polymers with a high melting point over 1,000° C., such as solid-state reaction, chemical vapor deposition (CVD), pulsed laser deposition (PLD), molecular beam epitaxy (MBE), sputtering, powder-in-tube (PIT) techniques, pellet making process, advanced dispersion techniques, chemical reactions, and casting, and the like.

As will be appreciated, embodiments of the present invention may be practiced in many ways. What follows in the paragraphs below is a non-limiting discussion of some embodiments of the present invention.

In accordance with the invention, new generation conductive polymers can be used for applications, such as electric wires, tapes and cables, electric wire harnesses, hot surface igniters, electronic devices, including battery, solar cell, LED, supercapacitor, and electrolyte, and light-weight structural materials for automobile and aerospace industry.

In one embodiment, an inorganic conductive polymer with a melting point over 1,000° C., with electrical resistivity ranging from 10^{˜6} Qcm to 10¹⁸ Qcm includes: Carbon, Mg, and Boron; magnetic ions formed in the polymer material; and non-magnetic ions formed in the polymer material. In another embodiment, a method for manufacturing a conductive polymer with a high melting point over 1,000° C. includes steps: preparing a polymer material having a resistivity ranging from 10^{˜6} Qcm to 10¹⁸ Qcm; forming magnetic ions in the polymer material; and forming non-magnetic ions in the polymer material.

Embodiments of the present invention can be easily adapted to Cu-sheathed conductive polymer wires, tapes, and cables, employing powder-in-tube (PIT) technique and extrusions.

While embodiments of the present invention have been exemplarily shown and described above, it will be understood by those skilled in the art that various changes in form and details may be made therein without departing from the spirit and scope of the invention as defined by the appended claims.

The following examples of the present invention are provided to illustrate the invention and are not intended to limit the scope thereof.

### EXAMPLE 1

For durable light weight structural material for automobile and aircraft, the insulating polymers look better. One insulating polymer with resistivity 0.2 MQcm was prepared by the pellet making process, as shown in FIG. 1. The atomic concentrations of ingredients are the following: C [19.81%], O [19.92%], Mg [56.11%], Ti [1.20%], and Co [2.96%]. It is very light, sturdy, and very strong.

### EXAMPLE 2

For applications in electronic devices and electric power transmission and distribution, highly conducting polymers are desirable. One highly conducting polymer sample was prepared by the PIT technique, as shown in FIG. 1, with the resistance, 3.3 mQ, as shown in FIG. 7. The atomic concentrations of the ingredients are the following: C [40.0%], O [5%], Mg [45.0%], Ti [5.0%], and Co [5.0%].

1. A conductive polymer or plastic with a high melting point over 1,000° C., based on Carbon, Mg, and Boron, and comprising magnetic ions and nonmagnetic ions, wherein it forms an amorphous polymer or plastic phase and its resistivity is varied from 10⁻⁶ ohmcm to 10¹⁸ ohmcm.

2. The polymer of claim 1, wherein a concentration of Carbon within the polymer material ranges from 5 at. % to 90 at. %.

3. The polymer of claim 1, wherein a concentration of Mg thin the polymer material ranges from 5 at. % to 90 at. %.

4. The polymer of claim 1, wherein a concentration of Boron within the polymer material ranges from 0 at. % to 50 at. %.

5. The polymer of claim 1, wherein the magnetic ions include at least one material selected from the group consisting of: Mn, Fe, Co, Ni, Cr, Ru, and Rh.

6. The polymer of claim 1, wherein the magnetic ions include at least one material selected from the group consisting of: Ce, Pr, Nd, Pm, Sm, Eu, Gd, Tb, Dy, Ho, Er, Tm, and U.

7. The polymer of claim 1, wherein a concentration of magnetic ions within the polymer material ranges from 0.1 at. % to 40 at. %.

8. The polymer of claim 1, wherein the non-magnetic ions include at least one material selected from the group consisting of: Zn, Ca, Al, Cu, Sc, Ti, V, 0, S, Si, Sn, Zr, Y, and Li.

9. The polymer of claim 1, wherein a concentration of nonmagnetic ions within the polymer material ranges from 1 at. % to 50 at. %.

10. A method for manufacturing a conductive polymer with a melting point over 1,000° C., comprising:
preparing a material, comprising C, Mg and B:
forming magnetic ions in the material; and
forming non-magnetic ions in the material,
employing high temperature sintering at least at 900 degrees C. or employing chemical synthesis,
wherein the electrical resistivity is varied from 10⁻⁶ ohmcm to 10¹⁸ ohmcm.

11. The polymer of claim 1, further comprising an electric wire, tape, and cable.

12. The polymer of claim 1, further comprising a conductive film.

13. The polymer of claim 1, further comprising a hot surface igniter.

14. The polymer of claim 1, further comprising an electronic device.

15. The polymer of claim 1, further comprising a light-weight structural material for automobile and aerospace ship.

16. The polymer of claim 1, further comprising a radiation-resistant material.

17. The polymer of claim 1, further comprising a conducting filament for 3d printing.

18. The polymer of claim 1, further comprising a conducting ink and/or paste.

19. The polymer of claim 14, wherein the electronic device comprises a battery, a capacitor, a PCB, a supercapacitor, an LED, a solar cell, an electrolyte, and at least one display.
